(19) United States
(12) Patent Application Publication
(10) Pub. No.: US 2026/0339378 A1
(43) Pub. Date: Oct. 29, 2026

(54) MULTI-DIRECTION INPUT DEVICE, CONTROL HANDLE HAVING THE DEVICE, AND OPERATION APPARATUS HAVING THE CONTROL HANDLE

(71) Applicant: SHENZHEN ZESUM TECHNOLOGY., LTD, Shenzhen (CN)

(72) Inventors: Yusho NAKASE, Shenzhen (CN); Wei YANG, Shenzhen (CN); Shi-Ying YANG, Shenzhen (CN); Chao-Xian CHEN, Shenzhen (CN)

(21) Appl. No.: 19/398,252

(22) Filed: Nov. 24, 2025

(30) Foreign Application Priority Data
Apr. 25, 2025 (CN) 202510529608.1

(51) Int. Cl. G05G 9/047

(52) U.S. Cl. CPC G05G 9/047; G05G 2009/04722; G05G 2009/04733; G05G 2009/04755

(57) ABSTRACT

A multi‑direction input device includes a housing with a cavity and a first opening; an operation member swingably disposed in the cavity and configured to be pressed; a circuit board; a magnetic sensing assembly; and a press switch. The operation member has an operation body with a first end protruding from the first opening and a protruding portion. A magnetic element on the protruding portion and a magnetic sensor on the circuit board sense magnetic changes as the operation member swings to indicate position of the operation body. The press switch on the circuit board is triggered by pressing the operation body to provide Z‑axis input, while X‑ and Y‑axis inputs are sensed magnetically to decouple axes. Options include a supporting member, a second opening, a pressing member, a limiter, and a return assembly. A control handle and an operation apparatus including the device are disclosed.

### CROSS-REFERENCE TO RELATED APPLICATIONS

The present application claims the benefit and priority to Chinese Patent Application Serial No. 202510529608.1, filed on Apr. 25, 2025, in China National Intellectual Property Administration, and the content of which is hereby fully incorporated by reference into the present application.

### FIELD

The subject matter relates to input devices, and particularly to a multi-direction input device, a control handle having the input device, and an operation apparatus having the control handle.

### BACKGROUND

Multi-direction input devices are widely used in control applications such as control handle. A joystick of the multi-direction input device can be operated along X and Y axes to realize precise control of a terminal equipment.

Carbon film sensors may be used to sense the operation of the joystick. However, the service life of the carbon film sensor is unsatisfactory. Furthermore, the carbon film sensor has environmental sensitivity, and the performance of the carbon film sensor may be degraded under high temperature and high humidity, thereby resulting in voltage drift and instable voltage output after a long time use. Furthermore, the resistance of the carbon film sensor may be abnormal under extreme environments. Dust or other impurities may also accumulated on the carbon film surface, which may affect the electrical contact of a terminal functioning on the carbon film sensor. The poor electrical contact results in degradation of signal transmission effect and input delay or mis operation. Therefore, there is room for improvement in the art.

### BRIEF DESCRIPTION OF THE DRAWINGS

Implementations of the present technology will now be described, by way of example only, with reference to the attached figures, wherein:

FIG. 1 is a schematic view of a multi-direction input device according to an embodiment of the present application.

FIG. 2 is an exploded view of the multi-direction input device of FIG. 1.

FIG. 3 is an exploded view of an operation member and a magnetic element of the multi-direction input device of FIG. 2.

FIG. 4 is a sectional view of the multi-direction input device of FIG. 1 taken along line IV–IV in one embodiment.

FIG. 5 is a sectional view of the multi-direction input device of FIG. 1 taken along line IV–IV in another embodiment.

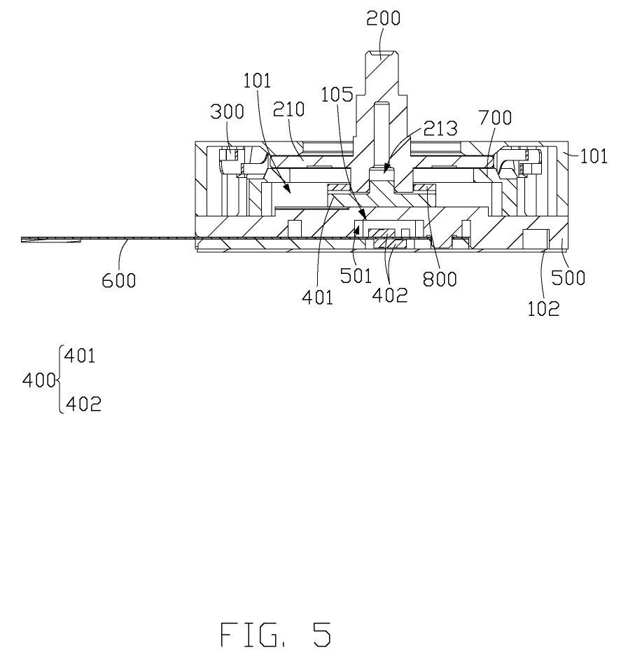

FIG. 6 is a block diagram of a control handle including the multi-direction input device.

FIG. 7 is a block diagram of an operation apparatus including the control handle.

### DETAILED DESCRIPTION

It will be appreciated that for simplicity and clarity of illustration, where appropriate, reference numerals have been repeated among the different figures to indicate corresponding or analogous elements. In addition, numerous specific details are set forth in order to provide a thorough understanding of the embodiments described herein. However, it will be understood by those of ordinary skill in the art that the embodiments described herein can be practiced without these specific details. In other instances, methods, procedures, and components have not been described in detail so as not to obscure the related relevant feature being described. Also, the description is not to be considered as limiting the scope of the embodiments described herein. The drawings are not necessarily to scale and the proportions of certain parts have been exaggerated to better illustrate details and features of the present disclosure.

For clarity, terms such as “first,” “second,” etc. are used for distinction and do not limit the scope. Unless otherwise stated, a first direction X, a second direction Y, and a third direction Z may be mutually perpendicular. The drawings are schematic and not necessarily to scale

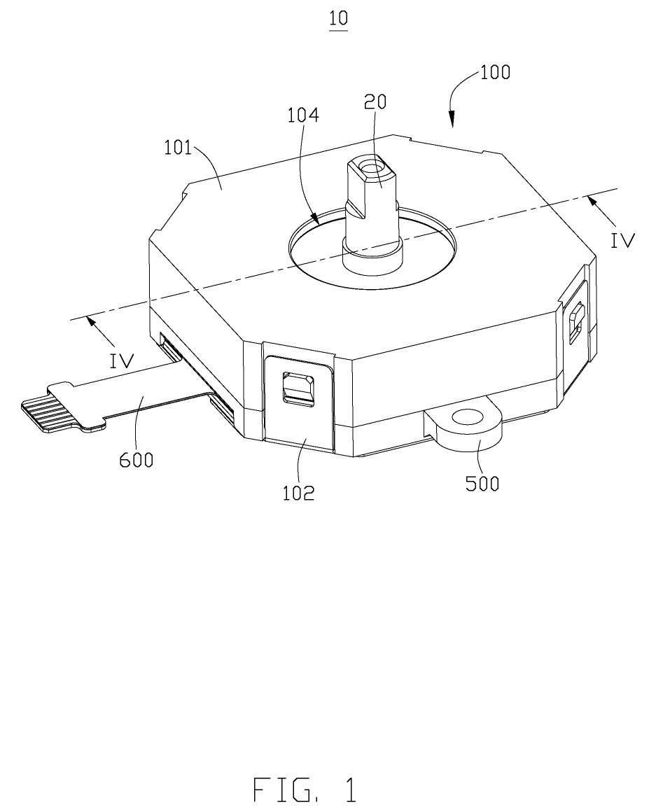

Referring to FIGS. 1-4, a multi-direction input device 10 is provided according to an embodiment of the present application. The multi-direction input device 10 includes a housing 100, an operating member 20, a circuit board 600, and a magnetic sensing assembly 400. The housing 100 defines a first cavity 103 and an opening 104 communicating with the first cavity 103. The operating member 20 is disposed within the first cavity 103 and can be titled or swung in the first cavity 103. The operating member 20 includes an operating body 200 and a peripheral protrusion 210. A first end 201 of the operating body 200 protrudes from the opening 104 for a user to operate. The circuit board 600 is disposed in the first cavity 103. The magnetic sensing assembly 400 includes a magnetic element 401 fixed to the protrusion 210 and a magnetic sensor 402 mounted on and electrically connected to the circuit board 600. A spacing 105 is maintained between the magnetic element 401 and the magnetic sensor 402. During the tilting of the operating member 20, the magnetic element 401 moves relative to the magnetic sensor 402. The magnetic sensor 402 detects changes in magnetic field strength or direction caused by the movement of the magnetic element 401, and such changes reflect the position of the operating body 200.

In this application, the existing carbon film is omitted, and the spacing 105 is defined between the magnetic element 401 and the magnetic sensor 402. Because no sliding contact occurs across that spacing 105, wear of the carbon film is avoided, and dust or other foreign particles are prevented from being in contact with the magnetic sensor 402, thereby avoiding surface contamination on the magnetic sensor 402 and increasing the service life of the magnetic sensor 402. Also, voltage shift and instable voltage output due to fouled contacts are suppressed, and signal stability is improved. Because the existing carbon film is omitted, abnormal resistance shifts of the carbon film caused by moisture absorption at high temperature/high humidity conditions are avoided, and therefore, the environmental sensitivity of the multi-direction input device 10 is reduced. Because the position of the operating body 200 is determined based on the changes in the magnetic field rather than ohmic value, the sensing accuracy is improved.

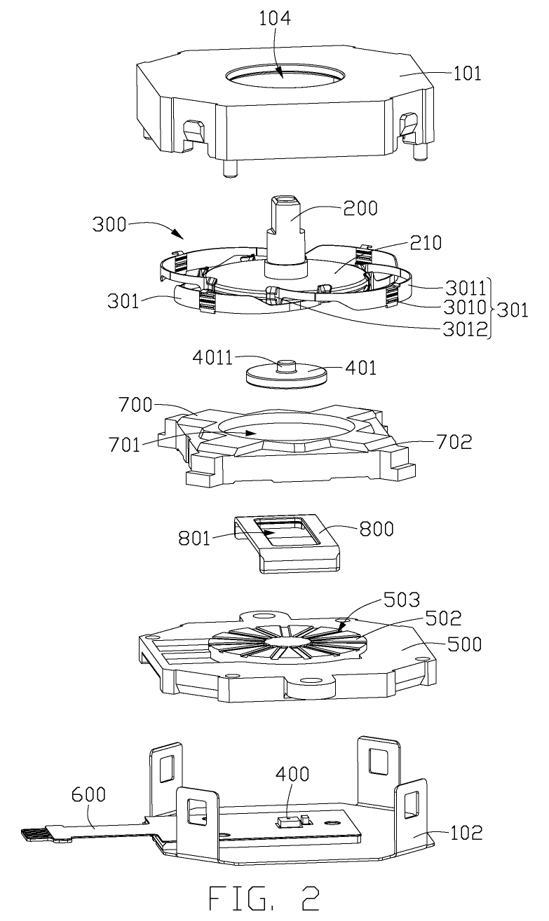

Referring to FIG. 2, the multi-direction input device 10 further includes a substrate 500. The substrate 500 is positioned in the housing 100 between the magnetic element 401 and the magnetic sensor 402. The substrate 500 provides physical separation that prevents direct contact between the magnetic element 401 and the magnetic sensor 402, and therefore, inadvertent short circuits are avoided. The substrate 500 acts as an insulating barrier to prevent short circuits and protect the magnetic sensor 402. The substrate stabilizes the magnetic element 401 and reduces electromagnetic interference, thereby improving the sensing accuracy.

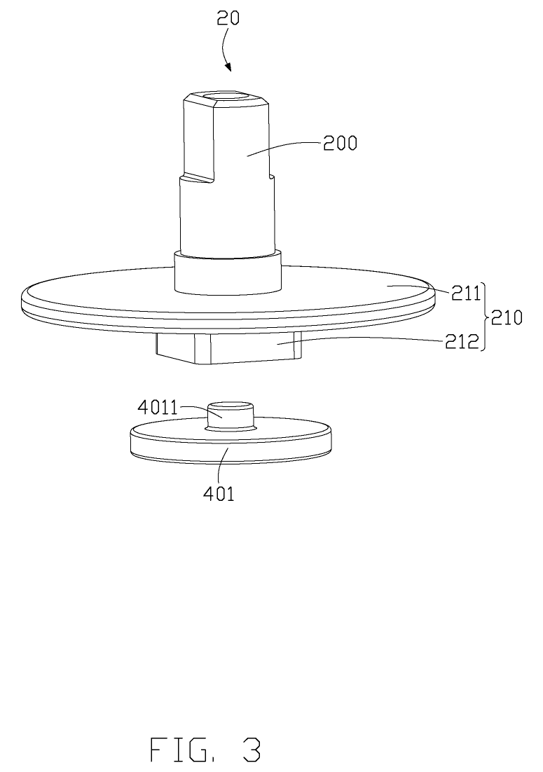

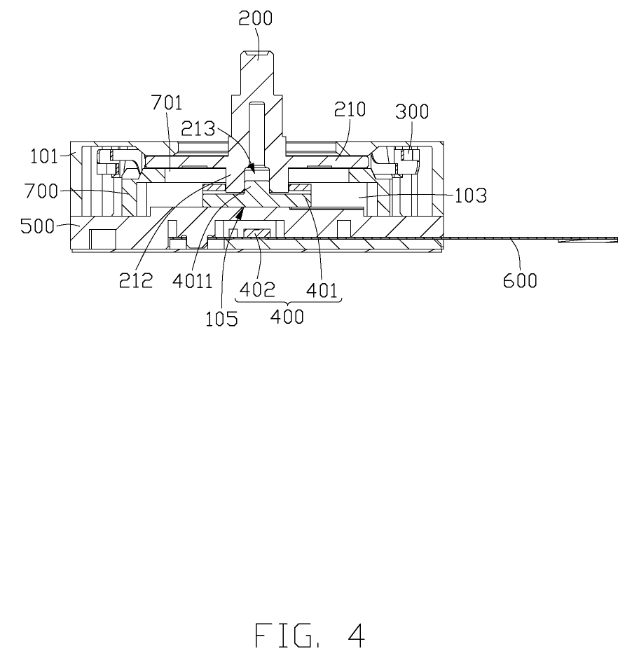

Referring to FIGS. 3 and 4, the housing 100 includes a first housing 101 and a second housing 102 connected to the first housing 101. The circuit board 600 is mounted inside the second housing 102, and the substrate 500 is stacked over the second housing 102 to define a second cavity 501 between the substrate 500 and the second housing 102. A portion of the circuit board 600 is located in the second cavity 501. Thus, the circuit board 600 can effectively isolate the magnetic sensor 402, thereby avoiding possible electromagnetic interference and improving the accuracy and sensitivity of the magnetic sensor 402. Furthermore, the second cavity 501 between the substrate 500 and the second housing 102 provides a sufficient space, which may improve the heat dissipation of the circuit board 600 inside the multi-directional input device 10. Moreover, the second cavity 501 can protect the circuit board 600 from external impacts and environmental factors, thereby improving the overall stability and service life of the multi-direction input device 10. Also, the housing 100 has a magnetic shielding function to prevent erroneous sensing. The influence of external magnetic fields on the magnetic sensor 402 is also reduced, thereby allowing the multi-directional input device 10 to accurately sense the operation of the user in various situations, to improving the overall control reliability of the multi-directional input device 10.

In some embodiments, a sliding platform 502 is formed on the substrate 500 facing the magnetic element 401. The magnetic element 401 abuts the sliding platform 502. Multiple shallow grooves 503 are arranged in a radial pattern on the platform. The grooves distribute contact pressure evenly and reduce friction. This arrangement ensures smooth motion of the magnetic element 401 and stable spacing 105 relative to the magnetic sensor 402, resulting in accurate sensing. The magnetic element 401 may be a neodymium-iron-boron magnet.

Referring to FIG. 4, the multi-direction input device 10 further includes a supporting member 700. The supporting member 700 is disposed on the substrate 500 on the side facing the first housing 101. A limiting opening 701 is formed in the supporting member 700 and communicates with the opening 104. The protrusion 210 is positioned through the limiting opening 701. The opening 104 limits the movement of the protrusion 210, preventing over-tilting or excessive pressing. This protects the internal parts and ensures consistent operation.

Referring to FIG. 2, the multi-direction input device 10 further includes a resetting mechanism 300.. The resetting mechanism 300 is disposed in the cavity 103 around the protrusion 210. The resetting mechanism 300 includes multiple C-shaped spring pieces 301. Each spring piece 301 has a fixing portion 3010, two elastic portions 3011 at its ends, and a driving portion 3012 connected to the protrusion 210. When the operation member 20 tilts, the elastic portions 3011 deform and store energy. When released, they restore the operation member 20 to the neutral position. Fixing the first portion 3010 to the supporting member 700 reduces friction and improves return precision. Using multiple springs distributes the load evenly, ensuring balance and durability.

Referring to FIGS. 2-4, in some embodiments, the protrusion 210 includes a disk-shaped rotating portion 211 and a connecting portion 212. The connecting portion 212 defines a slot 213. The magnetic element 401 has an engagement portion 4011 fixed in the slot 213. The connecting portion 212 extends through the limiting opening 701, which restricts lateral movement. The disk shape ensures smooth rotation and reduces side wobble. The connecting portion 212 may have a square section, improving its anti-rotation stability and maintaining consistent magnetic alignment.

Referring to FIGS. 2-4, in some embodiments, the multi-direction input device 10 further includes a limiting member 800. The limiting member 800 disposed above the substrate 500. The limiting member 800 defines a slot 801. The connecting portion 212 passes through and moves within the slot 801. The slot 801 limits the motion range of the operation member 20, preventing over-rotation. The shape of the slot 801 may be customized for different embodiments.

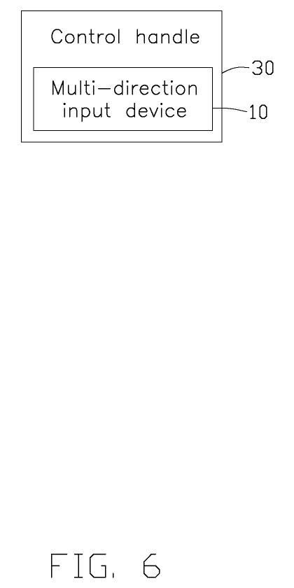

Referring to FIG. 6, in another embodiment, a control handle 30 including the multi-direction input device 10 is also provided. The spacing 105 between the magnetic element 401 and the magnetic sensor 402 prevents dust and other foreign matters from contacting the magnetic sensor 402 and reduces the voltage drift. As the operating member 20 drives the magnetic element 401 relative to the sensor 402, the control handle 30 outputs a position signal derived from the magnetic field other than the sliding resistance. Thus, this mechanism reduces or avoids wear caused by contact failure and improves the service life of the control handle 30.

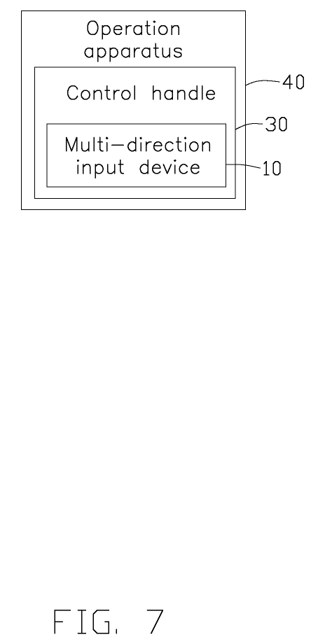

Referring to FIG. 7, in yet another embodiment, an operation apparatus 40 including the control handle 30 is further provided. The operation apparatus 40 receives a position signal from the magnetic sensing assembly 400 and converts it to control commands.

The embodiments shown and described above are only examples. Many details are often found in the art such as the other features of the lens module 100. Therefore, many such details are neither shown nor described. Even though numerous characteristics and advantages of the present technology have been set forth in the foregoing description, together with details of the structure and function of the present disclosure, the disclosure is illustrative only, and changes may be made in the detail, especially in matters of shape, size and arrangement of the parts within the principles of the present disclosure up to, and including the full extent established by the broad general meaning of the terms used in the claims. It will therefore be appreciated that the embodiments described above may be modified within the scope of the claims.

What is claimed is:

1. A multi-direction input device, comprising:
a housing defining a first cavity and an opening in communication with the first cavity;
an operation member at least partially disposed in the first cavity, the operation member comprising an operation body and a protrusion disposed at a periphery of the operation body, the operation body comprising a first end, and the first end protruding from the opening;
a circuit board disposed in the first cavity; and
a magnetic sensing assembly comprising a magnetic element fixed to the protrusion and a magnetic sensor mounted on and electrically connected to the circuit board,
wherein a spacing is defined between the magnetic element and the magnetic sensor, the magnetic element is configured to move with the operation member, and the magnetic sensor is configured to detect a change in a magnetic field generated by the magnetic element, and the magnetic sensor converts the change in the magnetic field into an indication of a positional change of the operation body.

2. The multi-direction input device of claim 1, further comprising a substrate disposed in the housing and located between the magnetic element and the magnetic sensor.

3. The multi-direction input device of claim 2, wherein the housing comprises a first housing and a second housing connected to the first housing, the circuit board is disposed on the second housing, the substrate is stacked on the second housing, a second cavity is defined between the substrate and the second housing, and at least a portion of the circuit board is fixed in the second cavity.

4. The multi-direction input device of claim 2, further comprising a slide platform, wherein the slide platform is at an end of the substrate facing the magnetic element, and the magnetic element is configured to abut against the slide platform.

5. The multi-direction input device of claim 3, further comprising a supporting member, wherein the supporting member is disposed on a side of the substrate facing the first housing, the supporting member defines a limiting opening communicating with the opening, and the protrusion is configured to abut against the supporting member.

6. The multi-direction input device of claim 5, further comprising a resetting mechanism disposed in the first cavity and elastically connected to a periphery of the protrusion, wherein the resetting mechanism is configured to return the operation member to a starting position, the resetting mechanism comprises a plurality of spring pieces, each of the plurality of spring pieces is C-shaped, each of the plurality of spring pieces comprises a first fixing portion, two elastic portions located at opposite ends of the first fixing portion, and a second driving portion located at an end of each of the two elastic portions away from the first fixing portion, the second driving portion is connected to the periphery of the protrusion, and the first fixing portion is fixed to the supporting member.

7. The multi-direction input device of claim 5, wherein the protrusion comprises a rotating portion and a connecting portion, the connecting portion defines a connection slot, the magnetic element comprises an engagement portion fixed in the connection slot, the connecting portion passes through the limiting opening, and the supporting member is configured to limit a movement of the connecting portion through the limiting opening.

8. The multi-direction input device of claim 7, further comprising a limiting member bridged over the substrate, wherein the limiting member defines a limiting slot, and the connecting portion passes through the limiting slot and is movable along the limiting slot.

9. A control handle, comprising a multi-direction input device, the multi-direction input device comprising:
a housing defining a first cavity and an opening in communication with the first cavity;
an operation member at least partially disposed in the first cavity, the operation member comprising an operation body and a protrusion disposed at a periphery of the operation body, the operation body comprising a first end, and the first end protruding from the opening;
a circuit board disposed in the first cavity; and
a magnetic sensing assembly comprising a magnetic element fixed to the protrusion and a magnetic sensor mounted on and electrically connected to the circuit board,
wherein a spacing is defined between the magnetic element and the magnetic sensor, the magnetic element is configured to move with the operation member, and the magnetic sensor is configured to detect a change in a magnetic field generated by the magnetic element, and the magnetic sensor converts the change in the magnetic field into an indication of a positional change of the operation body.

10. The control handle of claim 9, wherein the multi-direction input device further comprises a substrate disposed in the housing and located between the magnetic element and the magnetic sensor.

11. The control handle of claim 10, wherein the housing comprises a first housing and a second housing connected to the first housing, the circuit board is disposed on the second housing, the substrate is stacked on the second housing to define a second cavity between the substrate and the second housing, and at least a portion of the circuit board is fixed in the second cavity.

12. The control handle of claim 10, wherein the multi-direction input device further comprises a slide platform, the slide platform being provided at an end of the substrate facing the magnetic element, and the magnetic element abuts the slide platform.

13. The control handle of claim 11, wherein the multi-direction input device further comprises a supporting member disposed on a side of the substrate facing the first housing, a limiting opening formed in the supporting member communicates with the opening, and the protrusion abuts the supporting member.

14. The control handle of claim 13, wherein the multi-direction input device further comprises a resetting mechanism disposed in the first cavity and elastically connected to a periphery of the protrusion, the resetting mechanism being configured to return the operation member to a starting position, the resetting mechanism comprising a plurality of C-shaped spring pieces, each spring piece comprising a first fixing portion, two elastic portions located at opposite ends of the first fixing portion, and a second driving portion located at ends of the elastic portions away from the first fixing portion, the second driving portion being connected to the periphery of the protrusion, and the first fixing portion being fixed to the supporting member.

15. The control handle of claim 13, wherein the protrusion comprises a rotating portion and a connecting portion, the connecting portion defines a connection slot, the magnetic element comprises an engagement portion fixed in the connection slot, the connecting portion passes through the limiting opening, and the supporting member limits movement of the connecting portion through the limiting opening.

16. The control handle of claim 15, wherein the multi-direction input device further comprises a limiting member bridged over the substrate, the limiting member defining a limiting slot, and the connecting portion passes through the limiting slot and is movable along the limiting slot.

17. An operation apparatus, comprising a control handle, the control handle comprising a multi-direction input device, the multi-direction input device comprising:
a housing defining a first cavity and an opening in communication with the first cavity;
an operation member at least partially disposed in the first cavity, the operation member comprising an operation body and a protrusion disposed at a periphery of the operation body, the operation body comprising a first end, and the first end protruding from the opening;
a circuit board disposed in the first cavity; and
a magnetic sensing assembly comprising a magnetic element fixed to the protrusion and a magnetic sensor mounted on and electrically connected to the circuit board,
wherein a spacing is defined between the magnetic element and the magnetic sensor, the magnetic element is configured to move with the operation member, and the magnetic sensor is configured to detect a change in a magnetic field generated by the magnetic element, and the magnetic sensor converts the change in the magnetic field into an indication of a positional change of the operation body.

18. The operation apparatus of claim 17, wherein the multi-direction input device further comprises a substrate disposed in the housing and located between the magnetic element and the magnetic sensor.

19. The operation apparatus of claim 18, wherein the housing comprises a first housing and a second housing connected to the first housing, the circuit board is disposed on the second housing, the substrate is stacked on the second housing to define a second cavity between the substrate and the second housing, and at least a portion of the circuit board is fixed in the second cavity.

20. The operation apparatus of claim 18, wherein the multi-direction input device further comprises a slide platform, the slide platform being provided at an end of the substrate facing the magnetic element, and the magnetic element abuts the slide platform.
